(19) United States
(12) Patent Application Publication
(10) Pub. No.: US 2012/0122692 A1
(43) Pub. Date: May 17, 2012

(54) Method and Formulation for Eliminating Moss with Oregano Oil

(76) Inventor: William G. Rohlfsen, Mason City, IA (US)

(21) Appl. No.: 13/359,026

(22) Filed: Jan. 26, 2012

Related U.S. Application Data
(63) Continuation-in-part of application No. 11/604,081, filed on Nov. 24, 2006, now abandoned.

(51) Int. Cl. A01N 31/08; A01P 13/02; A01G 1/00; A01P 13/00

(52) U.S. Cl. 504/354; 47/57.7

(57) ABSTRACT

The composition for eliminating moss may be used in a method where the composition is applied to almost any surface where moss is growing. The composition includes an aqueous solution of essential oil. The oil is obtained from a plant and includes about 70% or more carvacrol. The composition may also contain a hydrocolloid.

### PRIORITY CLAIM

This application is a continuation-in-part of U.S. patent application Ser. No. 11/604,081 filed Nov. 24, 2006 and claims the benefit of that priority date.

### BACKGROUND OF THE INVENTION

1. Field of the Invention

This invention relates to the field of moss elimination methods and formulations, specifically the use of formulations of oregano oil extract and oil extracts from other plants.

2. Description of Related Art

Oregano oil extract, composed of carvacrol and thymol (add chemical formula below), is well known for its ability to suppress mold, fungus, and bacteria. Thymol has also been shown in U.S. Pat. No. 6,506,706 to be effective as a herbicide for controlling weeds and grass. Published U.S. Application No. 2004/0192551 discloses a herbicidal mixture of clove oil, thymol, and carvacrol.

Other plants that contain thymol typically include its isomer, carvacrol. Plants from which oil may be extacted for the purpose of the present invention include Monarda didyma, Monarda fistulosa, Trachyspermum ammi, Origanum compactum, Origanum dictamnus, Origanum onites, Origanum vulgare, Thymus glandulosus, Thymus hyemalis, Thymus vulgaris, and Thymus zygis.

Oregano oil extract and extracts from the other listed plants have not previously been shown as effective against moss. Moss includes any species of moss of the class Bryopsida such as for example, Bryum argenteum, any species of the division Bryophyta, any species of liverworts of class Marchantiopsida, and any species of hornworts of class Anthocerotopsida, and any other species commonly known as moss. Moss is a prevalent pest that grows on the surface of turf grass, lawns, landscaping materials, stone walls, wood, and roofing materials. Silvery thread moss, Bryum argenteum, for example, is a particularly vexing pest on golf courses.

Current methods of eliminating moss include the use of heavy metal compounds such as iron sulfate and copper hydroxide. In addition to being expensive, these compounds can cause surface staining and harm to living environments. Other compounds used to control moss include Dawn Ultra dish soap, baking soda, sodium carbonate peroxyhydrate. Herbicides have also been used to control the growth of moss. Quicksilver™, carfentrazone, is a herbicide that is sold for moss control. These other compounds and herbicides have not been effective in entirely eliminating moss and require multiple applications.

It is therefore desirable to use environmentally friendly compounds that are effective in eliminating moss. It is also desirable to formulate compositions of oregano oil to maximize its efficacy on moss. It is further desirable to use a formulation that will terminate moss in a single application but have minimal phytotoxicity to surrounding plants.

### SUMMARY OF THE INVENTION

The present invention provides a method and formulation for eliminating moss with oregano and other plant oil extracts. The oil extract is applied to moss (including liverwort) or a locus where moss exists to substantially kill the moss. A composition of about 0.5 weight percent oregano oil or greater is effective to substantially kill moss in only one application. The preferred method is to spray the oregano oil onto the moss or the locus, and the preferred formulation is a sprayable aqueous solution of oregano oil. To improve the efficacy of oregano oil, the preferred formulation includes one or more hydrocolloids.

Other objects, features, and advantages of the present invention will be readily appreciated from the following description. The description makes reference to the accompanying drawings, which are provided for illustration of the preferred embodiment. However, such embodiment does not represent the full scope of the invention. The subject matter which the inventor does regard as his invention is particularly pointed out and distinctly claimed in the claims at the conclusion of this specification.

### DESCRIPTION OF THE PREFERRED EMBODIMENTS

The present invention is a method and formulation of plant oil extract containing at least 70% concentration of carvacrol for killing moss. Unlike U.S. Pat. No. 6,506,706 and its method of using thymol, the method and formulation of the preferred embodiment of the present invention is not substantially toxic to grasses. It was surprising that only one application of the formulation of the preferred embodiment was found sufficient to kill moss. The single application damages plants mixed in with the moss, but the affected plants exhibit re-growth shortly thereafter whereas the affected moss does not. The method and formulation of the preferred embodiment is therefore well suited for killing moss on turf without significantly damaging the turf.

The method of the present invention involves the application of plant oil extract containing thymol and or its isomer, carvacrol wherein carvacrol is present in the extracted oil in at least about 70% concentration, onto moss or a locus where moss grows. In the preferred embodiment the plant oil is in an aqueous solution for application by spraying. Plant oils in amounts as low as about 0.25% by weight have been found to be effective in killing moss and amounts as low as about 0.5% by weight have been found sufficient to kill moss with one application.

Although oregano oil extract can be applied in concentrations as high as about 100% by weight, lower concentrations are preferable. About 100% oregano oil, as well as many other plant oils, is not flowable through a spray nozzle and is therefore more difficult to apply than lower concentrations. Further, the 100% plant oil has also been observed to roll off the surface of moss before it can act on the moss to kill it. The 100% oil is also significantly phytotoxic and may cause unintended harm to surrounding fauna.

After application of the plant oil, a locus may become contaminated with incoming mold spores. To prevent further contamination therefore includes the step of re-applying the plant oil. It is preferred to wait about two weeks before re-applications. Two weeks has been determined to be the optimal amount of time to prevent significant growth of moss from incoming spores while allowing other fauna at the locus to recover from the frequent treatments.

It is believed that the carvacrol or thymol or both in the plant oil chemically destroy the cell walls of moss. The outer walls of moss are studded with pectin binding sites. The pectin binding sites allow the moss to adhere to plants. These sites can also be adhered by certain hydrocolloids. Hydocolloids, also referred to as gums, that are believed to adhere to the pectin binding sites of moss include without limitation agar, alginates, acacia, arabinogalactan, caragum, carrageenan, chicory, guar, pectin, inulin, or xanthum. The preferred embodiment of the formula of the present invention includes hydrocolloids to aid in the interaction between the plant oil and the cells walls of the moss. Hydrocolloids of about 0.25 to about 25 percent by weight are therefore believed to enhance the action of the plant oil extract in killing moss.

The content of the present invention will be concretely explained by way of the following examples but the present invention shall not be limited only thereto.

### EXAMPLES OF METHODS AND FORMULATIONS

### Example 1

The formulation of oregano oil extract and hydrocolloids (formulation from claims) has been shown by the inventor to be effective in killing moss when applied as treatments on putting greens.

### Example 2

The combination of oregano oil extract and hydrocolloids ticgum, gum Arabic, and arabanoglactin was sprayed onto non-specific green moss growing on wood fencing. The combination eliminated all of the moss visible upon inspection and aided in the removal of the terminated moss.

### Example 3

Aqueous solutions of oregano oil extract were tested on silvery thread moss growing on turf grass. The turf grass was a mature stand of “Penncross” creeping bentgrass Agrostis stolonifera L. on a sand based rootzone. IA grid of six inch square plots were arranged on the turf. Each plot was initially rated for percent moss cover on July, 2006. Only plots with greater than 50% moss cover tracked for this test. Table 1 summarized the 79 treatments tested. Oregano oil extract formulations were compared with carefentrazone and a non-treated control. Several oregano oil formulation includes a surfactant, and these formation are marked as ORG AS, ORG BS, ORG CS, and ORG DS. Each formulation was applied as a squirt or pump from a spray bottle containing the formulation. The spray bottle used was one quart bottle that delivered 2.8 ml per pump onto a four inch square are. All of the formulations were applied at least once on Jul. 6, 2006. Sequential applications were also additionally performed bi-weekly on Jul. 20, Aug. 17 and Sep. 12, 2006 for a total of one, three, or four bi-weekly application. Each carefentrazone application was made at a recommended rate of 6.7 fl. Oz. product/A.

TABLE 1
Table 1
Turf quality, moss quality, and moss cover when various treatments of oregano oil
(ORG) and carfentrazone are applied to a creeping bentgrass putting green to
control silvery thread moss.

| | Oil | Volume | Total oil per | | | Applications | Applications |
|---|---|---|---|---|---|---|---|
| | Concentration | Water | Application | Applications | Applications | on | on |
| Treatment | (%) | ml · ft−2 | ml · ft−2 | on July 7 | on July 20 | August 17 | Sept. 12 |
| ORG A-11 | 0.25 | 25.5 | 0.06 | 1 | 0 | 0 | 0 |
| ORG A-13 | 0.25 | 25.5 | 0.06 | 1 | 1 | 1 | 0 |
| ORG A-16 | 0.25 | 25.5 | 0.06 | 1 | 1 | 1 | 1 |
| ORG A-21 | 0.25 | 51.0 | 0.13 | 2 | 0 | 0 | 0 |
| ORG A-23 | 0.25 | 51.0 | 0.13 | 2 | 2 | 2 | 0 |
| ORG A-26 | 0.25 | 51.0 | 0.13 | 2 | 2 | 2 | 2 |
| ORG A-41 | 0.25 | 102.0 | 0.26 | 4 | 0 | 0 | 0 |
| ORG A-43 | 0.25 | 102.0 | 0.26 | 4 | 4 | 4 | 0 |
| ORG A-46 | 0.25 | 102.0 | 0.26 | 4 | 4 | 4 | 4 |
| ORG AS11 | 0.25 | 25.5 | 0.06 | 1 | 0 | 0 | 0 |
| ORG AS13 | 0.25 | 25.5 | 0.06 | 1 | 1 | 1 | 0 |
| ORG AS16 | 0.25 | 25.5 | 0.06 | 1 | 1 | 1 | 1 |
| ORG AS21 | 0.25 | 51.0 | 0.13 | 2 | 0 | 0 | 0 |
| ORG AS23 | 0.25 | 51.0 | 0.13 | 2 | 2 | 2 | 0 |
| ORG AS26 | 0.25 | 51.0 | 0.13 | 2 | 2 | 2 | 2 |
| ORG AS41 | 0.25 | 102.0 | 0.26 | 4 | 0 | 0 | 0 |
| ORG AS43 | 0.25 | 102.0 | 0.26 | 4 | 4 | 4 | 0 |
| ORG AS46 | 0.25 | 102.0 | 0.26 | 4 | 4 | 4 | 4 |
| ORG B-11 | 0.5 | 25.5 | 0.13 | 1 | 0 | 0 | 0 |
| ORG B-13 | 0.5 | 25.5 | 0.13 | 1 | 1 | 1 | 0 |
| ORG B-16 | 0.5 | 25.5 | 0.13 | 1 | 1 | 1 | 1 |
| ORG B-21 | 0.5 | 51.0 | 0.26 | 2 | 0 | 0 | 0 |
| ORG B-23 | 0.5 | 51.0 | 0.26 | 2 | 2 | 2 | 0 |
| ORG B-26 | 0.5 | 51.0 | 0.26 | 2 | 2 | 2 | 2 |
| ORG B-41 | 0.5 | 102.0 | 0.51 | 4 | 0 | 0 | 0 |
| ORG B-43 | 0.5 | 102.0 | 0.51 | 4 | 4 | 4 | 0 |
| ORG B-46 | 0.5 | 102.0 | 0.51 | 4 | 4 | 4 | 4 |
| ORG BS11 | 0.5 | 25.5 | 0.13 | 1 | 0 | 0 | 0 |
| ORG BS13 | 0.5 | 25.5 | 0.13 | 1 | 1 | 1 | 0 |
| LSD.05 | | | | 1.52 | 1.47 | 1.27 | 1.52 |
| ORG BS16 | 0.5 | 25.5 | 0.13 | 1 | 1 | 1 | 1 |
| ORG BS21 | 0.5 | 51.0 | 0.26 | 2 | 0 | 0 | 0 |
| ORG BS23 | 0.5 | 51.0 | 0.26 | 2 | 2 | 2 | 0 |
| ORG BS26 | 0.5 | 51.0 | 0.26 | 2 | 2 | 2 | 2 |
| ORG BS41 | 0.5 | 102.0 | 0.51 | 4 | 0 | 0 | 0 |
| ORG BS43 | 0.5 | 102.0 | 0.51 | 4 | 4 | 4 | 0 |
| ORG BS46 | 0.5 | 102.0 | 0.51 | 4 | 4 | 4 | 4 |
| ORG C-11 | 1 | 25.5 | 0.26 | 1 | 0 | 0 | 0 |
| ORG C-13 | 1 | 25.5 | 0.26 | 1 | 1 | 1 | 0 |
| ORG C-16 | 1 | 25.5 | 0.26 | 1 | 1 | 1 | 1 |
| ORG C-21 | 1 | 51.0 | 0.51 | 2 | 0 | 0 | 0 |
| ORG C-23 | 1 | 51.0 | 0.51 | 2 | 2 | 2 | 0 |
| ORG C-26 | 1 | 51.0 | 0.51 | 2 | 2 | 2 | 2 |
| ORG C-41 | 1 | 102.0 | 1.02 | 4 | 0 | 0 | 0 |
| ORG C-43 | 1 | 102.0 | 1.02 | 4 | 4 | 4 | 0 |
| ORG C-46 | 1 | 102.0 | 1.02 | 4 | 4 | 4 | 4 |
| ORG CS11 | 1 | 25.5 | 0.26 | 1 | 0 | 0 | 0 |
| ORG CS13 | 1 | 25.5 | 0.26 | 1 | 1 | 1 | 0 |
| ORG CS16 | 1 | 25.5 | 0.26 | 1 | 1 | 1 | 1 |
| ORG CS21 | 1 | 51.0 | 0.51 | 2 | 0 | 0 | 0 |
| ORG CS23 | 1 | 51.0 | 0.51 | 2 | 2 | 2 | 0 |
| ORG CS26 | 1 | 51.0 | 0.51 | 2 | 2 | 2 | 2 |
| ORG CS41 | 1 | 102.0 | 1.02 | 4 | 0 | 0 | 0 |
| ORG CS43 | 1 | 102.0 | 1.02 | 4 | 4 | 4 | 0 |
| ORG CS46 | 1 | 102.0 | 1.02 | 4 | 4 | 4 | 4 |
| ORG D-11 | 2 | 25.5 | 0.51 | 1 | 0 | 0 | 0 |
| ORG D-13 | 2 | 25.5 | 0.51 | 1 | 1 | 1 | 0 |
| ORG D-16 | 2 | 25.5 | 0.51 | 1 | 1 | 1 | 1 |
| ORG D-21 | 2 | 51.0 | 1.02 | 2 | 0 | 0 | 0 |
| ORG D-23 | 2 | 51.0 | 1.02 | 2 | 2 | 2 | 0 |
| LSD.05 | | | | 1.52 | 1.47 | 1.27 | 1.52 |
| ORG D-26 | 2 | 51.0 | 1.02 | 2 | 2 | 2 | 2 |
| ORG D-41 | 2 | 102.0 | 2.04 | 4 | 0 | 0 | 0 |
| ORG D-43 | 2 | 102.0 | 2.04 | 4 | 4 | 4 | 0 |
| ORG D-46 | 2 | 102.0 | 2.04 | 4 | 4 | 4 | 4 |
| ORG DS11 | 2 | 25.5 | 0.51 | 1 | 0 | 0 | 0 |
| ORG DS13 | 2 | 25.5 | 0.51 | 1 | 1 | 1 | 0 |
| ORG DS16 | 2 | 25.5 | 0.51 | 1 | 1 | 1 | 1 |
| ORG DS21 | 2 | 51.0 | 1.02 | 2 | 0 | 0 | 0 |
| ORG DS23 | 2 | 51.0 | 1.02 | 2 | 2 | 2 | 0 |
| ORG DS26 | 2 | 51.0 | 1.02 | 2 | 2 | 2 | 2 |
| ORG DS41 | 2 | 102.0 | 2.04 | 4 | 0 | 0 | 0 |
| ORG DS43 | 2 | 102.0 | 2.04 | 4 | 4 | 4 | 0 |
| ORG DS46 | 2 | 102.0 | 2.04 | 4 | 4 | 4 | 4 |
| E11 | Carfentrazone | 25.5 | | 1 | 0 | 0 | 0 |
| E13 | Carfentrazone | 25.5 | | 1 | 1 | 1 | 0 |
| E16 | Carfentrazone | 25.5 | | 1 | 1 | 1 | 1 |
| ES11 | Carfentrazone | 25.5 | | 1 | 0 | 0 | 0 |
| ES13 | Carfentrazone | 25.5 | | 1 | 1 | 1 | 0 |
| ES16 | Carfentrazone | 25.5 | | 1 | 1 | 1 | 1 |
| Control | Control | | | 0 | 0 | 0 | 0 |
| LSD.05 | | | | 1.52 | 1.47 | 1.27 | 1.52 |

Table 2 shows the results in turf quality and percent moss cover. On Oct. 9, 2006, the non-treated control showed heavy moss infestation with 82% moss cover. Plots treated with several oregano oil formations (ORG B-26, ORG BS43, ORG B-43, and ORG C-13) had moss cover of approximately 20% or lower. The plots treated with carfentrazone treatments (E11, E13, 316, ES11, ES13, and ES16) had moss cover ranging from 48-77%. The test shows that moss can be substantially eliminated if low quality levels of turf are tolerable. For example, ORG-CS42 did not lower turf quality lower than 6.8 but reduced moss cover to less than ten percent.

TABLE 2
Table 2
Turf quality, moss quality, and moss cover when various treatments of
oregano oil (ORG) and carfentrazone are applied to a creeping bentgrass
putting green to control silvery thread moss.

| | 17 Aug | | 12 Sep | | 9 Oct | |
|---|---|---|---|---|---|---|
| | Turf | % Moss | Turf | % Moss | Turf | % Moss |
| Treatment | Quality | Cover | Quality | Cover | Quality | Cover |
| ORG A-11 | 10.0 | 58.8 | 10.0 | 60.0 | 10.0 | 58.0 |
| ORG A-13 | 10.0 | 64.0 | 10.0 | 79.8 | 10.0 | 69.8 |
| ORG A-16 | 10.0 | 77.0 | 10.0 | 81.8 | 9.8 | 66.8 |
| ORG A-21 | 10.0 | 78.8 | 10.0 | 77.0 | 10.0 | 74.0 |
| ORG A-23 | 10.0 | 73.0 | 10.0 | 74.0 | 10.0 | 74.0 |
| ORG A-26 | 10.0 | 59.0 | 10.0 | 73.0 | 10.0 | 56.0 |
| ORG A-41 | 10.0 | 67.0 | 10.0 | 71.0 | 10.0 | 62.0 |
| ORG A-43 | 10.0 | 50.8 | 10.0 | 61.0 | 10.0 | 61.0 |
| ORG A-46 | 10.0 | 59.8 | 10.0 | 58.0 | 10.0 | 62.0 |
| ORG AS11 | 10.0 | 71.0 | 10.0 | 76.6 | 10.0 | 67.6 |
| ORG AS13 | 10.0 | 63.0 | 10.0 | 66.0 | 10.0 | 67.0 |
| ORG AS16 | 10.0 | 83.0 | 10.0 | 82.0 | 10.0 | 71.8 |
| ORG AS21 | 10.0 | 92.8 | 9.6 | 88.6 | 10.0 | 90.6 |
| ORG AS23 | 10.0 | 66.0 | 10.0 | 84.0 | 10.0 | 70.0 |
| ORG AS26 | 9.8 | 71.0 | 10.0 | 74.0 | 10.0 | 78.0 |
| ORG AS41 | 10.0 | 39.8 | 10.0 | 61.0 | 10.0 | 59.0 |
| ORG AS43 | 10.0 | 59.0 | 10.0 | 69.0 | 9.6 | 61.0 |
| ORG AS46 | 9.8 | 57.0 | 10.0 | 56.4 | 10.0 | 51.8 |
| ORG B-11 | 10.0 | 87.8 | 10.0 | 75.0 | 10.0 | 78.0 |
| ORG B-13 | 9.8 | 65.0 | 10.0 | 51.8 | 10.0 | 50.0 |
| ORG B-16 | 10.0 | 66.0 | 10.0 | 56.0 | 10.0 | 45.0 |
| ORG B-21 | 9.6 | 53.0 | 9.6 | 50.0 | 10.0 | 53.0 |
| ORG B-23 | 9.8 | 51.0 | 10.0 | 39.0 | 10.0 | 30.0 |
| ORG B-26 | 10.0 | 34.0 | 10.0 | 21.0 | 10.0 | 20.4 |
| ORG B-41 | 10.0 | 40.0 | 10.0 | 58.0 | 10.0 | 41.0 |
| ORG B-43 | 10.0 | 13.0 | 10.0 | 5.2 | 10.0 | 8.0 |
| ORG B-46 | 9.2 | 15.0 | 9.6 | 9.6 | 9.2 | 10.6 |
| ORG BS11 | 10.0 | 72.0 | 10.0 | 76.0 | 10.0 | 61.0 |
| ORG BS13 | 10.0 | 75.0 | 10.0 | 71.0 | 10.0 | 79.0 |
| LSD.05 | 1.27 | 26.3 | 1.25 | 27.1 | 1.54 | 27.7 |
| ORG BS16 | 10.0 | 75.0 | 10.0 | 70.0 | 10.0 | 66.0 |
| ORG BS21 | 10.0 | 69.0 | 10.0 | 61.2 | 10.0 | 66.0 |
| ORG BS23 | 10.0 | 47.0 | 10.0 | 54.2 | 10.0 | 46.0 |
| ORG BS26 | 10.0 | 66.0 | 10.0 | 36.0 | 10.0 | 46.0 |
| ORG BS41 | 9.6 | 56.0 | 8.8 | 48.0 | 9.6 | 58.0 |
| ORG BS43 | 10.0 | 42.0 | 10.0 | 8.8 | 10.0 | 17.4 |
| ORG BS46 | 9.4 | 31.0 | 9.0 | 16.4 | 8.8 | 22.0 |
| ORG C-11 | 10.0 | 30.0 | 10.0 | 44.0 | 9.8 | 36.0 |
| ORG C-13 | 9.6 | 24.0 | 9.0 | 13.0 | 8.8 | 20.2 |
| ORG C-16 | 9.2 | 31.0 | 9.2 | 15.4 | 8.0 | 20.0 |
| ORG C-21 | 10.0 | 16.0 | 10.0 | 20.4 | 9.8 | 20.0 |
| ORG C-23 | 7.6 | 12.0 | 8.2 | 3.6 | 8.6 | 12.0 |
| ORG C-26 | 8.0 | 10.6 | 6.6 | 1.8 | 5.8 | 6.4 |
| ORG C-41 | 9.4 | 8.0 | 9.4 | 13.0 | 9.4 | 17.0 |
| ORG C-43 | 8.0 | 5.0 | 5.8 | 2.0 | 7.2 | 13.0 |
| ORG C-46 | 6.6 | 3.0 | 6.6 | 2.6 | 3.8 | 1.2 |
| ORG CS11 | 10.0 | 44.0 | 9.8 | 68.0 | 10.0 | 55.0 |
| ORG CS13 | 10.0 | 54.0 | 10.0 | 24.2 | 10.0 | 38.0 |
| ORG CS16 | 10.0 | 56.2 | 9.4 | 33.4 | 8.2 | 37.4 |
| ORG CS21 | 9.6 | 44.0 | 10.0 | 57.0 | 9.6 | 40.4 |
| ORG CS23 | 9.6 | 27.0 | 8.8 | 10.4 | 9.2 | 20.0 |
| ORG CS26 | 9.0 | 43.0 | 8.2 | 17.4 | 6.8 | 19.4 |
| ORG CS41 | 9.8 | 14.0 | 9.8 | 27.0 | 10.0 | 35.0 |
| ORG CS43 | 7.6 | 10.0 | 6.8 | 5.2 | 7.0 | 9.8 |
| ORG CS46 | 5.8 | 6.6 | 4.8 | 2.6 | 4.8 | 3.2 |
| ORG D-11 | 9.0 | 23.0 | 10.0 | 30.0 | 10.0 | 29.0 |
| ORG D-13 | 4.8 | 2.2 | 3.6 | 4.2 | 3.4 | 9.4 |
| ORG D-16 | 5.2 | 4.8 | 4.0 | 1.6 | 2.6 | 1.4 |
| ORG D-21 | 6.2 | 11.2 | 8.0 | 11.8 | 8.6 | 24.2 |
| ORG D-23 | 2.8 | 1.2 | 2.0 | 1.4 | 3.0 | 5.8 |
| LSD.05 | 1.27 | 26.3 | 1.25 | 27.1 | 1.54 | 27.7 |
| ORG D-26 | 3.0 | 1.0 | 2.0 | 1.4 | 1.8 | 1.4 |
| ORG D-41 | 5.6 | 5.0 | 6.2 | 4.0 | 6.2 | 11.4 |
| ORG D-43 | 1.0 | 1.0 | 1.0 | 1.0 | 1.0 | 2.0 |
| ORG D-46 | 1.0 | 1.0 | 1.0 | 1.0 | 1.0 | 1.0 |
| ORG DS11 | 8.8 | 22.0 | 8.4 | 32.0 | 9.2 | 45.0 |
| ORG DS13 | 6.0 | 3.4 | 4.8 | 5.2 | 5.0 | 13.4 |
| ORG DS16 | 6.0 | 9.0 | 5.6 | 4.0 | 4.0 | 3.4 |
| ORG DS21 | 8.4 | 4.4 | 9.2 | 9.2 | 9.6 | 25.0 |
| ORG DS23 | 2.6 | 1.2 | 2.4 | 1.4 | 2.6 | 3.2 |
| ORG DS26 | 3.0 | 1.2 | 2.0 | 1.4 | 2.0 | 1.0 |
| ORG DS41 | 4.0 | 2.0 | 4.8 | 3.0 | 6.2 | 14.2 |
| ORG DS43 | 1.0 | 1.0 | 1.0 | 1.0 | 1.0 | 2.2 |
| ORG DS46 | 1.0 | 1.0 | 1.0 | 1.0 | 1.0 | 1.8 |
| E11 | 10.0 | 60.0 | 10.0 | 66.0 | 10.0 | 48.0 |
| E13 | 9.6 | 68.8 | 10.0 | 73.8 | 10.0 | 70.8 |
| E16 | 10.0 | 58.0 | 10.0 | 59.0 | 9.6 | 55.0 |
| ES11 | 10.0 | 82.0 | 10.0 | 65.8 | 10.0 | 77.0 |
| ES13 | 10.0 | 81.8 | 10.0 | 75.0 | 10.0 | 63.0 |
| ES16 | 10.0 | 55.8 | 10.0 | 61.8 | 10.0 | 55.8 |
| Control | 10.0 | 78.0 | 10.0 | 80.8 | 10.0 | 82.8 |
| LSD.05 | 1.27 | 26.3 | 1.25 | 27.1 | 1.54 | 27.7 |

The data from the test were analyzed using PROC ANOVA of the SAS software, Version 8 of the SAS System for Windows (SAS Institute, 1999). Means were separated (alpha=0.05) by Fischer's protected LSD (Fischer, 1966). Turf quality was rated on a scale of 1-10, where 10=best turf with no phyoxicity, 6=lowest acceptable turf quality and turf phytotoxicity, 1=worst turf quality with most phytotosixity and completely brown turf.

Thereafter, the combination of a plant oil extract which was not oregano but having at least about 70% carvacrol and a hydrocolloid ticgum, gum arabic, arabanoglactin in accordance with the present invention was sprayed onto non-specific green moss growing on wood fencing. Additional testing was done including essential oils from at least one other plant type which exhibited at least about 70% carvacrol and the combination eliminated all of the moss as determined by visible inspection and aided in the removal of the terminated moss. Plant oil containing carvacrol may be extracted from a number of different species. Specifically, thyme, pepperwort, wild bergamot, some species of Satureja, and O. onites var. Symrnaeum.

Thus, the present invention has been described in an illustrative manner. It is to be understood that the terminology that has been used is intended to be in the nature of words of description rather than of limitation.

Many modifications and variations of the present invention are possible in light of the above teachings. For example, any weight percent of the disclosed plant oil can effectively kill moss if correctly applied. The formulation can include any components that do not significantly reduce the efficacy of the oregano oil or other extracted plant oils containing thymol and carvacrol where carvacrol concentration in the extracted oil is at concentrations of at least about 70%, and preferably higher than 80%. Therefore, within the scope of the appended claims, the present invention may be practiced otherwise than as specifically described.

What I claim is:

1. A method of substantially eliminating moss comprising application of plant oil extract in an aqueous solution to said moss, wherein said plant oil extract comprises at least about 70% carvacrol and said aqueous solution includes at least one hydrocolloid for adhering said oil to the pectin binding sites of the moss.

2. The method of claim 1 wherein said hydrocolloid comprises at least one from the group consisting of agar, alginates, acacia, arabinogalactan, caragum, carrageenan, chicory, guar, pectin, inulin, and xanthum.

3. The method of claim 2 wherein said plant oil extract is about 0.5% to about 100% weight percent of said aqueous solution.

4. The method of claim 3 wherein said aqueous solution of said plant oil extract comprises at least about 80% carvacrol.

5. The method of claim 4 wherein said aqueous solution comprises a surfactant.

6. The method of claim 1 wherein said aqueous solution of said plant oil extract includes a plurality of hydrocolloids.

7. The method of claim 3 wherein said aqueous solution of said plant oil extract includes about 0.35% to about 25% by weight of said at least one hydrocolloid.

8. The method of claim 7 wherein said aqueous solution of said plant oil extract further includes about 0.25 to 25 weight percent of at least one hydrocolloid as an emulsifier.

9. The method of claim 3 wherein said aqueous solution of said plant oil extract is applied to said moss by spraying said solution thereon.

10. The method of claim 9 wherein said aqueous solution of said plant oil extract is applied to a surface bearing said moss.

11. The method of claim 10 wherein said surface comprises at least one from the group consisting of grass, lawn, landscaping material, stone, wood, asphalt, and composite roofing material.

12. The method of claim 3 wherein the plant oil extract is about 50% to about 95% by weight of said aqueous solution.

13. The method of claim 10 wherein said aqueous solution of said plant oil extract is reapplied to said surface after about two weeks to prevent recontamination.

14. A method for elimination of moss on host plants without significant permanent damage to the host plant wherein said method comprises application of a plant oil extract composition causing moss death due to cell wall destruction.

15. The composition of claim 14 said composition comprising:
plant oil extract having at least about 70% carvacrol;
at least one hydrocolloid; and
water.

16. The composition of the method of claim 14 comprising:
about 0.5 to about 99.75 weight percent to plant oil extract;
about 0.25 to about 25 weight percent of at least one hydrocolloid;
about 0.25 to about 99.5 weight percent water.

17. The composition of claim 15 wherein said hydrocolloid is selected from the group consisting of agar, alginates, acacia, arabinogalactan, caragum, carrageenan, chicory, guar, pectin, inulin, and xanthum.

18. The composition of claim 15 wherein said composition is sprayable.

19. A method for controlling growth of moss which comprises applying an effective amount of an aqueous solution of plant oil extract to a surface wherein said plant oil extract comprises at least about 70% carvacrol.

20. The method of claim 18 wherein said plant oil extract is sprayed onto said surface.

21. The method of claim 19 wherein said surface comprises one or more selected from the group consisting of plants, trees, grass, lawn, landscaping material, stone, wood, asphalt, and roofing material.
